(19) United States
(12) Patent Application Publication
(10) Pub. No.: US 2025/0357462 A1
(43) Pub. Date: Nov. 20, 2025

(54) APPARATUS AND METHOD FOR MANUFACTURING DRY ELECTRODE SHEET

(71) Applicant: SK On Co., Ltd., Seoul (KR)

(72) Inventors: Yeong Jun JI, Daejeon (KR); Hyeong Uk CHOI, Daejeon (KR)

(21) Appl. No.: 19/084,758

(22) Filed: Mar. 20, 2025

(30) Foreign Application Priority Data
May 17, 2024 (KR) 10-2024-0064578

(51) Int. Cl. H01M 4/04

(52) U.S. Cl. CPC H01M 4/0435

(57) ABSTRACT

Proposed is an apparatus and method for manufacturing a dry electrode sheet. The apparatus includes a material feeder supplying an electrode material, a pair of sheet forming rollers facing each other and forming an electrode sheet by pressurizing the electrode material supplied from the material feeder, a first force sensor connected to each of the sheet forming rollers and measuring a force applied to each of the sheet forming rollers, a thickness sensor measuring a thickness of the electrode sheet, a gap adjuster connected to each of the sheet forming rollers and adjusting the gap between the sheet forming rollers, and a controller controlling the gap adjuster to adjust the gap between the sheet forming rollers on the basis of a force value measured by the first force sensor so that the thickness of the electrode sheet received from the thickness sensor matches a target value.

### CROSS REFERENCE TO RELATED APPLICATION

The present application claims priority to Korean Patent Application No. 10-2024-0064578, filed May 17, 2014, the entire contents of which is incorporated herein for all purposes by this reference.

### TECHNICAL FIELD

The present disclosure relates to an apparatus and method for manufacturing a dry electrode sheet.

### BACKGROUND

A battery manufacturing process for secondary batteries includes an electrode manufacturing process.

The electrode manufacturing process includes a mixing process that mixes an electrode active material, a conductive material, and a binder to prepare a slurry, a coating process that coats the slurry on an aluminum or copper foil, and a dry process that dries the electrode with the slurry coated on the foil.

In addition, a battery electrode is manufactured by dispersing an electrode mixture containing an electrode active material, a conductive material, and a binder in water or a solvent to prepare an electrode active material slurry, coating the electrode active material slurry on a foil, and then drying the electrode active material slurry.

Meanwhile, a dry electrode process that does not use a solvent has been proposed recently to improve the conventional electrode manufacturing process.

The dry electrode process involves manufacturing a dry electrode sheet by calendaring an electrode mixture containing an electrode active material, a conductive material, and a binder, and then manufacturing a positive or negative electrode by bonding the dry electrode sheet to an aluminum or copper foil.

This dry electrode process is a newly developed solvent-free electrode process for improving electrode quality, and various research and development are currently being conducted on it.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure is to provide an apparatus and method for manufacturing a dry electrode sheet, the apparatus and method being capable of manufacture of a dry electrode sheet.

The apparatus and method for manufacturing a dry electrode sheet according to an aspect of the present disclosure being capable of controlling the thickness of the dry electrode sheet during manufacture.

The apparatus and method for manufacturing a dry electrode sheet according to an aspect of the present disclosure being capable of wide application in green technology fields such as electric vehicles, battery charging stations, and solar and wind power generation using batteries.

The apparatus and method for manufacturing a dry electrode sheet according to an aspect of the present disclosure being capable of application in manufacture of secondary batteries, which are used in eco-friendly electric vehicles, hybrid vehicles, and the like to prevent climate change by suppressing air pollution and greenhouse gas emissions.

According to an aspect of the present disclosure, there is provided an apparatus for manufacturing a dry electrode sheet, the apparatus including: a material feeder configured to supply an electrode material; a pair of sheet forming rollers facing each other and configured to form an electrode sheet by pressurizing the electrode material supplied from the material feeder; a first force sensor connected to each of the pair of sheet forming rollers and configured to measure a force applied to each of the pair of sheet forming rollers; a thickness sensor configured to measure a thickness of the electrode sheet; a gap adjuster connected to each of the pair of sheet forming rollers and configured to adjust a gap between the pair of sheet forming rollers; and a controller configured to control the gap adjuster to adjust the gap between the pair of sheet forming rollers on the basis of a force value measured by the first force sensor so that the thickness of the electrode sheet received from the thickness sensor matches a target value.

In an embodiment, the controller may control an opening ratio of the material feeder or a discharge pressure of the material feeder so that the thickness of the electrode sheet received from the thickness sensor matches the target value.

In an embodiment, the first force sensor may include a load cell connected to one or each of the pair of sheet forming rollers and configured to measure a force applied in a direction in which the pair of sheet forming rollers are moved farther away from or closer to each other, and the thickness sensor may include any one of a spectral interference-type thickness sensor, an infrared absorption-type thickness sensor, and a radiation-type thickness sensor.

In an embodiment, the gap adjuster may include: a linear-type gap adjuster configured to move one or each of the pair of sheet forming rollers and linearly move the pair of sheet forming rollers in a direction in which the pair of sheet forming rollers are moved closer to or farther away from each other; or a rotary-type gap adjuster configured to rotate one of the pair of sheet forming rollers clockwise or counterclockwise around an axis outside the sheet forming roller and rotate the remaining one of the pair of sheet forming rollers counterclockwise or clockwise around an axis outside the sheet forming roller so that the pair of sheet forming rollers are rotated in opposite directions and moved in a direction closer to or farther away from each other.

In an embodiment, the apparatus may further include: a blade disposed on each of the pair of sheet forming rollers and positioned so as to be in contact with each of the pair of sheet forming rollers in a direction in which the pair of sheet forming rollers are moved farther away from each other; a second force sensor configured to measure a force applied to the blade in a direction in which the pair of sheet forming rollers are moved farther away from each other; and a pressurizer connected to the blade and configured to pressurize the blade toward the sheet forming roller. The controller may control the pressurizer on the basis of a force value received from the second force sensor.

In an embodiment, the blade may be a plate-shaped body with a length corresponding to that of each of the pair of sheet forming rollers, the second force sensor may be a load cell, and the pressurizer may be a pressurizing cylinder with a cylinder rod connected to the blade or a pressurizing rotary motor with a rotation shaft connected to the blade.

According to an aspect of the present disclosure, there is provided a method for manufacturing a dry electrode sheet, the method including: an electrode material supply step in which a material feeder supplies an electrode material to a pair of sheet forming rollers; an electrode sheet formation step in which the pair of sheet forming rollers are rotated to pressurize the electrode material, thereby forming an electrode sheet; a thickness measurement step in which a thickness sensor measures a thickness of the electrode sheet; a force measurement step in which a first force sensor connected to each of the pair of sheet forming rollers measures a force applied to each of the pair of sheet forming rollers; a thickness comparison step in which a controller compares the thickness of the electrode sheet received from the thickness sensor with a preset target value; a force comparison step in which the controller compares the force received from the first force sensor with a preset reference value; and a control step in which the controller controls a gap adjuster that adjusts a gap between the pair of sheet forming rollers on the basis of a force value measured by the first force sensor so that the thickness of the electrode sheet received from the thickness sensor matches the target value.

In an embodiment, the method may further include: a normal operation determination step in which the controller determines that the thickness of the electrode sheet is in a normal state when the thickness of the electrode sheet is determined to match the preset target value in the thickness comparison step.

In an embodiment, the force comparison step may be performed when the controller determines that the thickness of the electrode sheet is smaller than the preset target value in the thickness comparison step or determines that the thickness of the electrode sheet is larger than the preset target value in the thickness comparison step. The control step may include: a first control signal output step in which the controller outputs a control signal for increasing the thickness of the electrode sheet when the thickness of the electrode sheet is determined to be smaller than the preset target value in the thickness comparison step and the force applied to each of the pair of sheet forming rollers is smaller than the reference value; a second control signal output step in which the controller outputs a control signal for reducing the thickness of the electrode sheet when the thickness of the electrode sheet is determined to be larger than the preset target value in the thickness comparison step and the force applied to each of the pair of sheet forming rollers is larger than the reference value; and a hunting determination step in which the controller determines that an intermittent hunting phenomenon occurs when the thickness of the electrode sheet is determined to be smaller than the preset target value in the thickness comparison step and the force applied to each of the pair of sheet forming rollers is larger than the reference value or when the thickness of the electrode sheet is determined to be larger than the preset target value in the thickness comparison step and the force applied to each of the pair of sheet forming rollers is smaller than the reference value.

In an embodiment, in the first control signal output step, the controller may output one of a control signal for increasing an opening ratio of the material feeder, a control signal for increasing a discharge pressure of the material feeder, and a control signal for increasing a gap between the pair of sheet forming rollers through the gap adjuster, and in the second control signal output step, the controller may output one of a control signal for reducing the opening ratio of the material feeder, a control signal for reducing the discharge pressure of the material feeder, and a control signal for reducing the gap between the pair of sheet forming rollers through the gap adjuster.

In an embodiment, the method may further include: a step in which a second force sensor measures a force applied to a blade disposed on each of the pair of sheet forming rollers in a direction in which the pair of sheet forming rollers are moved farther away from each other; a step in which the controller compares a force value received from the second force sensor with a preset setting value; and a step in which the controller controls a pressurizer that pressurizes the blade toward the sheet forming roller so that the blade pressurizes the sheet forming roller when the force applied to the blade is larger than the preset setting value.

The features and advantages of the present disclosure will be more clearly understood from the following detailed description when taken in conjunction with the accompanying drawings.

All terms or words used in the specification and claims have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

According to the present disclosure, it is possible to manufacture a dry electrode sheet.

According to the present disclosure, it is possible to adjust the thickness of the manufactured dry electrode sheet.

According to the present disclosure, it is possible to enable mass production of the dry electrode sheet while adjusting the thickness of the dry electrode sheet.

According to the present disclosure, it is possible to improve the stability and efficiency of process performance in manufacture of the dry electrode sheet.

According to the present disclosure, it is possible to manufacture a dry electrode sheet with a uniform thickness, and enable a highly reliable process and control to be performed.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating an apparatus for manufacturing a dry electrode sheet according to an embodiment;

FIG. 2 is a view illustrating the apparatus for manufacturing the dry electrode sheet according to the embodiment, the apparatus including a first force sensor;

FIG. 3 is a schematic view illustrating a linear-type gap adjuster in the apparatus for manufacturing the dry electrode sheet according to the embodiment;

FIG. 4 is a schematic view illustrating a rotary-type gap adjuster in the apparatus for manufacturing the dry electrode sheet according to the embodiment;

FIG. 5 is a view illustrating the apparatus for manufacturing the dry electrode sheet according to the embodiment, the apparatus further including a blade and a second force sensor and using a pressurizing cylinder as a pressurizer;

FIG. 6 is a view illustrating the apparatus for manufacturing the dry electrode sheet according to the embodiment, the apparatus further including the blade and the second force sensor and using a pressurizing rotary motor as a pressurizer;

FIG. 7 is a flowchart illustrating a method for manufacturing a dry electrode sheet according to an embodiment;

FIG. 8 is a detailed flowchart illustrating a thickness comparison step to a control step in the method for manufacturing the dry electrode sheet according to the embodiment; and

FIG. 9 is a flowchart illustrating a method of using a blade and a second force sensor in the method for manufacturing the dry electrode sheet according to the embodiment.

### DETAILED DESCRIPTION

Reference will now be made in greater detail to exemplary embodiments of the present disclosure with reference to the accompanying drawings. However, the embodiments are provided as exemplary examples, and the spirit of the present disclosure are not limited to those specific embodiments.

The drawings may be schematic or exaggerated to illustrate embodiments.

In this document, the expression “may include” or the like specifies the presence of stated features (e.g., a numerical value, function, operation, or element such as a part), but does not preclude the presence of additional features.

Hereinbelow, exemplary embodiments of the present disclosure will be described in detail with reference to the accompanying drawings.

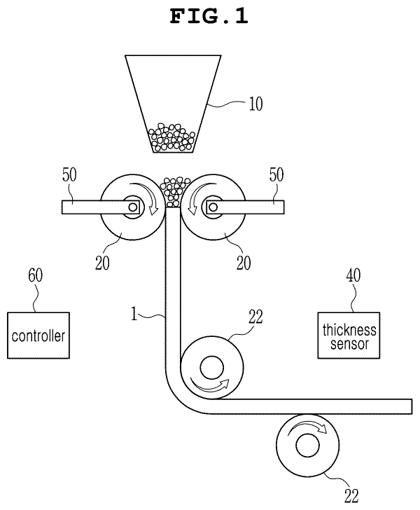

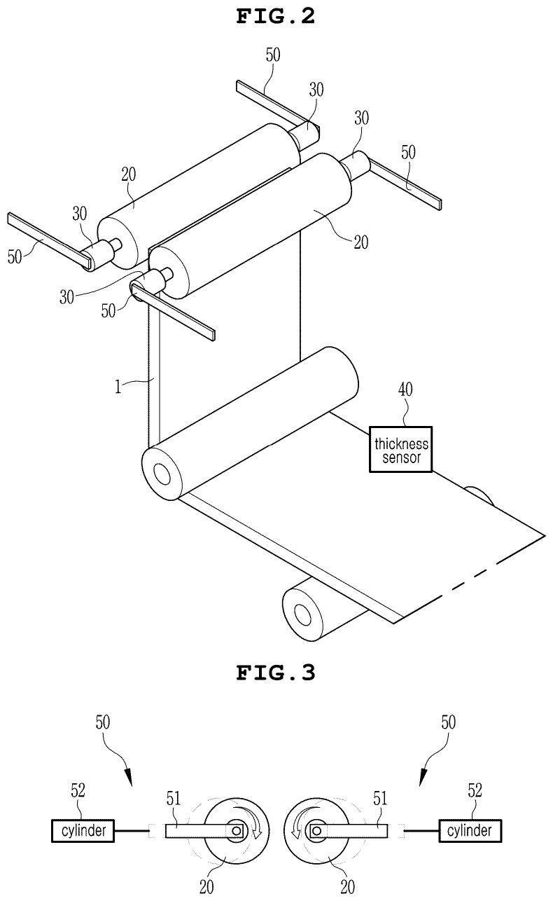

FIG. 1 is a view illustrating an apparatus for manufacturing a dry electrode sheet according to an embodiment. FIG. 2 is a view illustrating the apparatus for manufacturing the dry electrode sheet according to the embodiment, the apparatus including a first force sensor.

Referring to FIGS. 1 and 2, the apparatus for manufacturing the dry electrode sheet according to the present disclosure may include: a material feeder 10 supplying an electrode material; a pair of sheet forming rollers 20 facing each other and forming an electrode sheet 1 by pressurizing the electrode material supplied from the material feeder 10; a first force sensor 30 connected to each of the pair of sheet forming rollers 20 and measuring a force applied to each of the pair of sheet forming rollers 20; a thickness sensor 40 measuring a thickness of the electrode sheet 1; a gap adjuster 50 connected to each of the pair of sheet forming rollers 20 and adjusting a gap between the pair of sheet forming rollers 20; and a controller 60 controlling the gap adjuster 50 to adjust the gap between the pair of sheet forming rollers 20 on the basis of a force value measured by the first force sensor 30 so that the thickness of the electrode sheet 1 received from the thickness sensor 40 matches a target value.

The material feeder 10 supplies the electrode material, and may have various body shapes, such as a hopper-type structure.

The material feeder 10 may include a guide dam having an opening ratio that is adjusted to control a supply amount of the electrode material, or a die nozzle having a discharge pressure that is adjusted to discharge the electrode material.

The electrode material may be an electrode mixture containing an electrode active material and a binder.

The electrode material may be an electrode mixture containing an electrode active material, a conductive material, and a binder.

The electrode material may be in a kneading state in which an electrode mixture is kneaded, or may be in a mixed powder state in which an electrode mixture is mixed.

The pair of sheet forming rollers 20 may be disposed so that two rollers are positioned on the left and right sides to face each other, and may be rotated relative to each other to pressurize the electrode material and produce an electrode sheet. The pair of sheet forming rollers 20 may include two rollers spaced apart from each other.

The pair of sheet forming rollers 20 are rotary bodies having a predetermined controlled rotational force, and may be rotated at a predetermined speed by directly receiving a rotational power of a motor or receiving a power through a power transmission member such as a belt.

The electrode material may be supplied through the material feeder 10, and the electrode material supplied may be pressurized with the pair of sheet forming rollers 20, thereby manufacturing an electrode sheet 1 with a predetermined thickness.

The electrode sheet 1 manufactured through the pair of sheet forming rollers 20 may be guided for transfer by a guide roller 22 and may be prevented from being separated to the outside. A plurality of guide rollers 22 may be installed. The plurality of guide rollers 22 may be rotated in a moving direction of the electrode sheet 1 to transfer the electrode sheet 1.

The first force sensor 30 may include a load cell that is connected to one or each of the pair of sheet forming rollers 20 and measures a force applied in a direction in which the pair of sheet forming rollers 20 are moved farther away from or closer to each other. The thickness sensor 40 may include any one of a spectral interference-type thickness sensor, an infrared absorption-type thickness sensor, and a radiation-type thickness sensor.

The first force sensor 30 may have an end connected to each of the pair of sheet forming rollers 20 and may measure a force applied to each of the pair of sheet forming rollers 20 and transmit the measured force to the controller 60. The first force sensor 30 may detect whether the force applied to each of the pair of sheet forming rollers 20 is a force that moves the pair of sheet forming rollers 20 facing each other farther away from or closer to each other. The first force sensor 30 may measure the force applied to each of the pair of sheet forming rollers 20. One first force sensor 30 may be mounted on each end of each of the pair of sheet forming rollers 20. The first force sensor 30 may be a rod-shaped load cell.

The pair of sheet forming rollers 20 are rotating bodies that are rotationally driven. Basically, a force exists between the pair of sheet forming rollers 20 to move the pair of sheet forming rollers 20 farther away from each other due to the electrode material. In order to maintain the thickness of the electrode sheet 1 manufactured, a force needs to be applied to the pair of sheet forming rollers 20 in a direction in which the pair of sheet forming rollers 20 are moved closer to each other so that the gap therebetween is maintained. The first force sensor 30 may measure the force applied to each of the pair of sheet forming rollers 20 to confirm the direction of the applied force, and may detect whether the force is applied in a direction in which the pair of sheet forming rollers 20 are moved farther away from or closer to each other.

The thickness sensor 40 may measure the thickness of the electrode sheet 1 formed by pressurizing of the pair of sheet forming rollers 20.

In the thickness sensor 40, the spectral interference-type thickness sensor may use any one of a laser, an LED, and a halogen lamp as a light source, and may measure the thickness by irradiating the light source and utilizing interference of reflected light.

In the thickness sensor 40, the infrared absorption-type thickness sensor may measure the thickness by irradiating infrared light and measuring the absorbance of a specific wavelength using a spectral spectrum of transmitted light or reflected light.

In the thickness sensor 40, the radiation-type thickness sensor may measure the thickness by irradiating radiation such as X-rays or B-rays and comparing the amount of backscatter of a background and the amount of scatter of a film.

The gap adjuster 50 may include a linear-type gap adjuster moving one or each of the pair of sheet forming rollers 20 and linearly moving the pair of sheet forming rollers 20 in a direction in which the pair of sheet forming rollers 20 are moved closer to or farther away from each other, or a rotary-type gap adjuster rotating one of the pair of sheet forming rollers 20 clockwise or counterclockwise around an axis outside the sheet forming roller 20 and rotating the remaining one of the pair of sheet forming rollers 20 counterclockwise or clockwise around an axis outside the sheet forming roller 20 so that the pair of sheet forming rollers 20 are rotated in opposite directions and moved in a direction closer to or farther away from each other.

The gap adjuster 50 may be connected to each of the pair of sheet forming rollers 20 using a bearing or the like so as not to interfere with the rotational force of the pair of sheet forming rollers 20. The gap adjuster 50 may adjust the gap between the pair of sheet forming rollers 20, thereby increasing or reducing thickness of the electrode sheet 1 manufactured.

The gap adjuster 50 may be connected to the first force sensor 30 connected to each of the pair of sheet forming rollers 20.

FIG. 3 is a schematic view illustrating a linear-type gap adjuster in the apparatus for manufacturing the dry electrode sheet according to the embodiment.

Referring to FIG. 3, the gap adjuster 50 may be formed as a linear type. Here, “linear type” means that the pair of sheet forming rollers 20 are moved in a straight line along a direction closer to or farther away from each other.

The gap adjuster 50 may include a pair of gap adjustment bars 51 connected to the pair of sheet forming rollers 20, respectively, and a pair of cylinders 52 connected to the pair of gap adjustment bars 51, respectively.

Each of the pair of gap adjustment bars 51 may have a first end connected to each of the pair of sheet forming rollers 20 and a second end connected to each of the pair of cylinders 52. The gap adjustment bar 51 may be connected using a bearing that makes surface contact with a rotation axis of the sheet forming roller 20 so as not to interfere with the rotational force of the sheet forming roller 20 for pressurizing the electrode material.

The pair of cylinders 52 may be driven in simultaneous operation according to a control output from the controller 60, thereby adjusting the gap between the pair of sheet forming rollers 20 to move the pair of sheet forming rollers 20 closer to or farther away from each other.

Each of the pair of gap adjustment bars 51 may have a first end connected to the first force sensor 30 connected to each of the pair of sheet forming rollers 20 and a second end connected to each of the pair of cylinders 52.

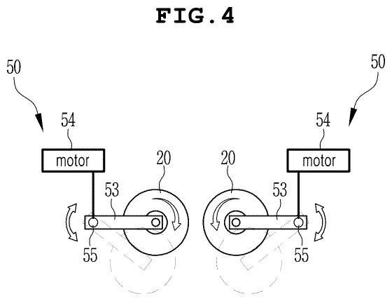

FIG. 4 is a schematic view illustrating a rotary-type gap adjuster in the apparatus for manufacturing the dry electrode sheet according to the embodiment.

Referring to FIG. 4, the gap adjuster 50 may be formed as a rotary type. Here, “rotary type” means that one of the pair of sheet forming rollers 20 is rotated clockwise or counterclockwise around an axis outside the sheet forming roller 20, and the remaining one of the pair of sheet forming rollers 20 is rotated counterclockwise or clockwise around an axis outside the sheet forming roller 20, thereby moving the pair of sheet forming rollers 20 closer to or farther away from each other.

The gap adjuster 50 may include a pair of handlers 53 connected to the pair of sheet forming rollers 20, respectively, and a pair of motors 54 rotationally driving the pair of handlers 53, respectively.

Each of the pair of handlers 53 may have a first end connected to each of the pair of sheet forming rollers 20 and a second end connected to a rotation shaft 55 of each of the pair of motors 54. The handler 53 may be connected using a bearing that makes surface contact with a rotation axis of the sheet forming roller 20 so as not to interfere with the rotational force of the sheet forming roller 20 for pressurizing the electrode material.

Each of the pair of motors 54 may include a reducer for stable driving and control of the handler 53.

The pair of handlers 53 may be rotated clockwise or counterclockwise relative to each other by rotating the pair of motors 54 in opposite directions according to a control output from the controller 60, thereby adjusting the gap between the pair of sheet forming rollers 20 to move the pair of sheet forming rollers 20 closer to or farther away from each other.

Each of the pair of handlers 53 may have a first end connected to the first force sensor 30 connected to each of the pair of sheet forming rollers 20 and a second end connected to the rotation shaft 55 of each of the pair of motors 54.

As described above, the operation of the gap adjuster 50 may be controlled according to a control signal from the controller 60.

The controller 60 may compare the thickness of the electrode sheet 1 received from the thickness sensor 40 with the target value.

The controller 60 may control the gap adjuster 50 on the basis of the force value measured by the first force sensor 30 so that the thickness of the electrode sheet 1 received from the thickness sensor 40 matches the target value, thereby adjusting the gap between the pair of sheet forming rollers 20.

The controller 60 may reduce the thickness of the electrode sheet 1 manufactured by reducing the gap between the pair of sheet forming rollers 20, and increase the thickness of the electrode sheet 1 manufactured by increasing the gap between the pair of sheet forming rollers 20.

The controller 60 may control the opening ratio of the material feeder 10 or the discharge pressure of the material feeder 10 so that the thickness of the electrode sheet 1 received from the thickness sensor 40 matches the target value.

The controller 60 may reduce the thickness of the electrode sheet 1 by reducing the opening ratio of the material feeder 10 or reducing the discharge pressure of the material feeder 10 while maintaining a constant gap between the pair of sheet forming rollers 20, thereby reducing the supply amount of the electrode material, and increase the thickness of the electrode sheet 1 by increasing the opening ratio of the material feeder 10 or increasing the discharge pressure of the material feeder 10, thereby increasing the supply amount of the electrode material.

The controller 60 may control the gap adjuster 50 on the basis of the force value measured by the first force sensor 30 so that the thickness of the electrode sheet 1 received from the thickness sensor 40 matches the target value, thereby manufacturing an electrode sheet 1 having a desired thickness.

As described above, the present disclosure proposes a manufacturing apparatus capable of performing a continuous process, thereby enabling continuous manufacture of an electrode sheet and enabling mass production of an electrode sheet while controlling the thickness thereof.

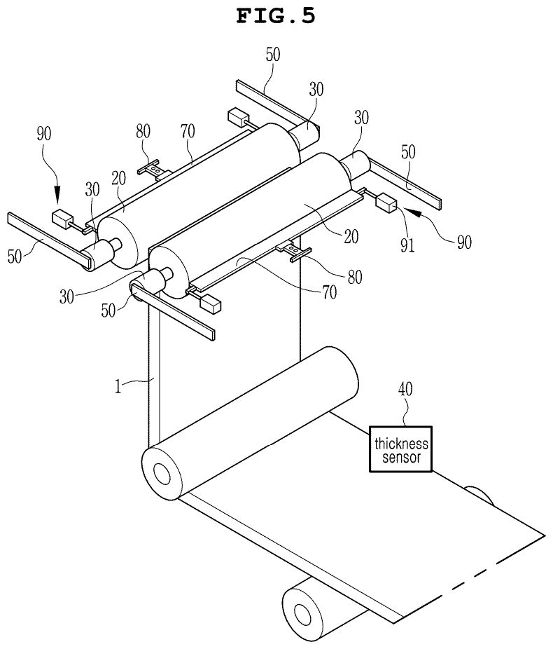

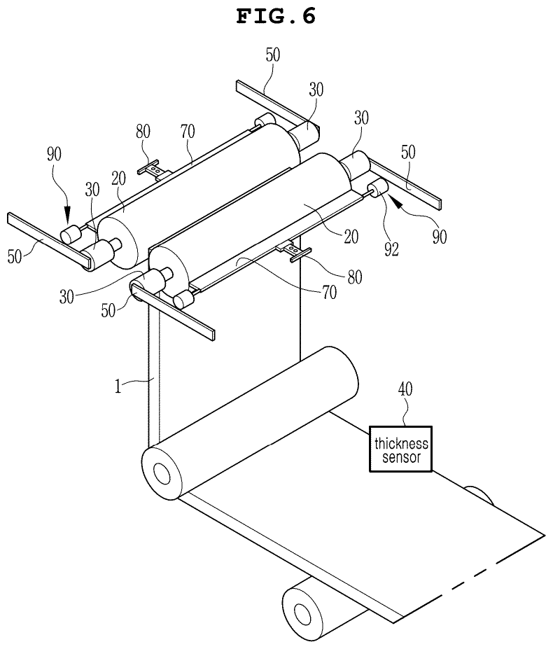

FIG. 5 is a view illustrating the apparatus for manufacturing the dry electrode sheet according to the embodiment, the apparatus further including a blade and a second force sensor and using a pressurizing cylinder as a pressurizer. FIG. 6 is a view illustrating the apparatus for manufacturing the dry electrode sheet according to the embodiment, the apparatus further including the blade and the second force sensor and using a pressurizing rotary motor as a pressurizer.

Referring to FIGS. 5 and 6, the apparatus for manufacturing the dry electrode sheet according to the present disclosure may include: a blade 70 disposed on each of the pair of sheet forming rollers 20 and positioned so as to be in contact with each of the pair of sheet forming rollers 20 in a direction in which the pair of sheet forming rollers 20 are moved farther away from each other; a second force sensor 80 measuring a force applied to the blade 70 in a direction in which the pair of sheet forming rollers 20 are moved farther away from each other; and a pressurizer 90 connected to the blade 70 and pressurizing the blade 70 toward the sheet forming roller 20. The controller 60 may control the pressurizer 90 on the basis of a force value received from the second force sensor 80.

The blade 70 is a plate-shaped body with a length corresponding to that of each of the pair of sheet forming rollers 20. The second force sensor 80 may be a load cell. The pressurizer 90 may be a pressurizing cylinder 91 with a cylinder rod connected to the blade 70 or a pressurizing rotary motor 92 with a rotation shaft connected to the blade 70.

The pressurizing cylinder 91 or the pressurizing rotary motor 92 may be positioned on each end of the sheet forming roller 20.

The blade 70 may be made of synthetic resin or metal.

When the blade 70 is made of synthetic resin, various types of synthetic resins, including polyethylene (PE), may be used.

The blade 70 may perform an auxiliary role of scraping off an electrode material attached to the sheet forming roller 20. The electrode material scraped off from the sheet forming roller 20 through the blade 70 may be sucked into a dust collector and then sent to the material feeder 10 for reuse.

The second force sensor 80 may measure the force applied to the blade 70 disposed on each of the pair of sheet forming rollers 20 in a direction in which the pair of sheet forming rollers 20 are moved farther away from each other.

The pressurizer 90 may use the pressurizing cylinder 91 or the pressurizing rotary motor 92 depending on whether the gap adjuster 50 described above with reference to FIGS. 3 and 4 is a linear type or a rotary type.

When a linear-type gap adjuster 50 is used, the pressurizing cylinder 91 may be used together, and when a rotary-type gap adjuster 50 is used, the pressurizing rotary motor 92 may be used together. The pressurizing rotary motor 92 may include a reducer for stable rotational driving and control of the blade 70.

The controller 60 may compare the force value received from the second force sensor 80 with a preset setting value, and control the pressurizer 90 to pressurize the blade 70 toward the sheet forming roller 20 when the force applied to the blade 70 is larger than the preset setting value, thereby controlling the blade 70 to pressurize the sheet forming roller 20.

In the case where the gap adjuster 50 is a linear type, when adjusting the gap between the pair of sheet forming rollers 20 by linearly moving the pair of sheet forming rollers 20 in a direction closer to or farther away from each other, the controller 60 may simultaneously control the pressurizing cylinder 91 in the same direction to continuously maintain contact between the blade 70 and the sheet forming roller 20.

In the case where the gap adjuster 50 is a rotary type, when adjusting the gap between the pair of sheet forming rollers 20 by rotationally moving the pair of sheet forming rollers 20 in a direction closer to or farther away from each other, the controller 60 may simultaneously control the pressurizing rotary motor 92 at the same rotation radius to continuously maintain contact between the blade 70 and the sheet forming roller 20.

During operation, the pair of sheet forming rollers 20 have a force that causes the pair of sheet forming rollers 20 facing each other to be moved farther away from each other from their original installation positions due to the electrode material. This may result in a problem of deviation in the thickness of the electrode sheet 1 manufactured. In the present disclosure, the second force sensor 80 may detect a force applied in a direction in which the pair of sheet forming rollers 20 are moved farther away from each other via the blade 70, and at this time, the operation of the pressurizer 90 may be controlled on the basis of a measurement value from the second force sensor 80. This prevents the pair of sheet forming rollers 20 from being moved farther away from each other.

Accordingly, in the present disclosure, when manufacturing the electrode sheet 1, it is possible to prevent occurrence of a thickness deviation caused by a mechanical characteristic in which a force is applied to the pair of sheet forming rollers 20 facing each other to move the pair of sheet forming rollers 20 farther away from each other due to the electrode material.

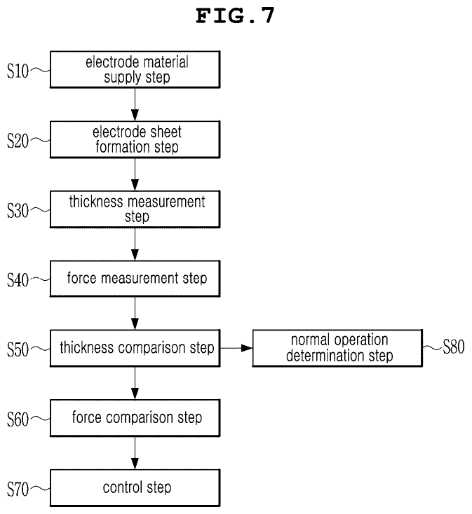

FIG. 7 is a flowchart illustrating a method for manufacturing a dry electrode sheet according to an embodiment. FIG. 1 and FIG. 2 will be referenced together.

Referring to FIG. 7, the method for manufacturing the dry electrode sheet according to the present disclosure may include: an electrode material supply step S10 in which a material feeder 10 supplies an electrode material to a pair of sheet forming rollers 20; an electrode sheet formation step S20 in which the pair of sheet forming rollers 20 are rotated to pressurize the electrode material, thereby forming an electrode sheet 1; a thickness measurement step S30 in which a thickness sensor 40 measures a thickness of the electrode sheet 1; a force measurement step S40 in which a first force sensor 30 connected to each of the pair of sheet forming rollers 20 measures a force applied to each of the pair of sheet forming rollers 20; a thickness comparison step S50 in which a controller 60 compares the thickness of the electrode sheet 1 received from the thickness sensor 40 with a preset target value; a force comparison step S60 in which the controller 60 compares the force received from the first force sensor 30 with a preset reference value; and a control step S70 in which the controller 60 controls a gap adjuster 50 that adjusts a gap between the pair of sheet forming rollers 20 on the basis of a force value measured by the first force sensor 30 so that the thickness of the electrode sheet 1 received from the thickness sensor 40 matches the target value.

The electrode material supply step S10 is a step in which an electrode mixture in a kneading state or an electrode mixture in a mixed powder state is supplied to the pair of sheet forming rollers 20 by the material feeder 10.

The electrode sheet formation step S20 is a step in which the electrode material supplied in the electrode material supply step S10 is pressurized by the pair of sheet forming rollers 20 rotating at a predetermined speed to form an electrode sheet 1 with a predetermined thickness. The electrode sheet 1 may be guided through a plurality of guide rollers 22 and transferred along its moving direction.

The thickness measurement step S30 is a step in which the thickness of the electrode sheet 1 formed with the predetermined thickness by the pair of sheet forming rollers 20 and transferred in the electrode sheet formation step S20 is measured by the thickness sensor 40. Thickness data of the electrode sheet 1 measured in the thickness measurement step S30 may be used in the thickness comparison step S50.

The force measurement step S40 is a step in which the force applied to each of the pair of sheet forming rollers 20 is measured by the first force sensor 30 while the pair of sheet forming rollers 20 are in operation to form the electrode sheet 1. Force data applied to each of the pair of sheet forming rollers 20 measured in the force measurement step S40 may be used in the force comparison step S60. The pair of sheet forming rollers 20 are rotating bodies that are rotationally driven. Basically, a force exists between the pair of sheet forming rollers 20 to move the pair of sheet forming rollers 20 farther away from each other due to the electrode material. In order to maintain the thickness of the electrode sheet 1 manufactured, a force needs to be applied to the pair of sheet forming rollers 20 in a direction in which the pair of sheet forming rollers 20 are moved closer to each other so that the gap therebetween is maintained. The first force sensor 30 may measure the force applied to each of the pair of sheet forming rollers 20 to confirm the direction of the applied force, and may detect whether the force is applied in a direction in which the pair of sheet forming rollers 20 are moved farther away from or closer to each other.

The thickness comparison step S50 is a step in which a current thickness state of the electrode sheet 1 is checked using the thickness data of the electrode sheet 1 measured in the thickness measurement step S30. In the thickness comparison step S50, the controller 60 may compare the thickness of the electrode sheet 1 received from the thickness sensor 40 with the preset target value and determine whether the thickness of the electrode sheet 1 is smaller than the preset target value.

In the thickness comparison step S50, the controller 60 may determine whether the thickness of the electrode sheet 1 is larger than the preset target value in the thickness comparison step S50.

In the thickness comparison step S50, the controller 60 may determine whether the thickness of the electrode sheet 1 matches the preset target value in the thickness comparison step S50.

The force comparison step S60 is a step in which the controller 60 checks whether the pair of sheet forming rollers 20 are displaced by using the force data applied to each of the pair of sheet forming rollers 20 measured in the force measurement step S40. The force comparison step S60 is a step in which the controller 60 receives the force value applied to each of the pair of sheet forming rollers 20 from the first force sensor 30 on the basis of a data comparison result in the thickness comparison step S50 and compares the force value with the preset reference value.

In the force comparison step S60, the controller 60 may receive the force value applied to each of the pair of sheet forming rollers 20 from the first force sensor 30, compare the force value with the preset reference value, and determine whether the force value is larger or smaller than the preset reference value.

The control step S70 is a step in which the controller 60 controls the gap adjuster 50 according to comparison results in the thickness comparison step S50 and the force comparison step S60 to adjust the thickness of the electrode sheet 1.

In the control step S70, the controller 60 may control the gap adjuster 50 to adjust the gap between the pair of sheet forming rollers 20 so that the pair of sheet forming rollers 20 are moved closer to or farther away from each other, thereby increasing or decreasing the thickness of the electrode sheet 1.

In the control step S70, the controller 60 may control the material feeder 10 to adjust the thickness of the electrode sheet 1. The thickness of the electrode sheet 1 may be increased or reduced by controlling a supply amount of the electrode material by controlling an opening ratio of the material feeder 10 or a discharge pressure of the material feeder 10.

In the present disclosure, the electrode sheet 1 may be manufactured through the electrode material supply step S10 to the control step S70. In particular, through the thickness measurement step S30 to the control step S70, it is possible to enable the electrode sheet 1 to be adjusted in the thickness and manufactured with a uniform thickness, and enable a highly reliable process to be performed in manufacture and thickness adjustment of the electrode sheet 1.

The method for manufacturing the dry electrode sheet according to the present disclosure may further include: a normal operation determination step S80 in which the controller 60 determines that the thickness of the electrode sheet 1 is in a normal state when the thickness of the electrode sheet 1 is determined to match the preset target value in the thickness comparison step S50.

In the normal operation determination step S80, “normal operation” means a state in which thickness adjustment does not need to be performed on the electrode sheet 1 formed by pressurizing the electrode material through the pair of sheet forming rollers 20.

The normal operation determination step S80 is a step in which the controller 60 maintains a current control state without changing a control output and continues to manufacture the electrode sheet 1.

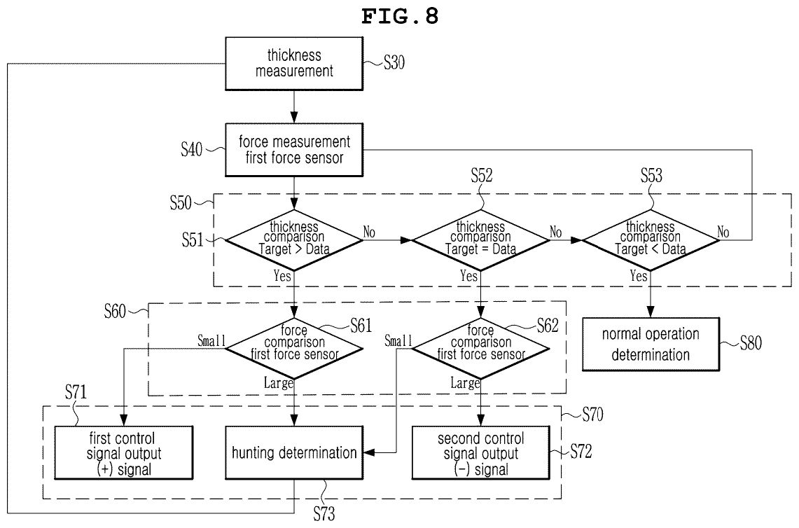

FIG. 8 is a detailed flowchart illustrating a thickness comparison step to a control step in the method for manufacturing the dry electrode sheet according to the embodiment. FIG. 1 and FIG. 2 will be referenced together.

Referring to FIG. 8, the force comparison step S60 may be performed when the thickness of the electrode sheet 1 is determined to be smaller than the preset target value in the thickness comparison step S50 or when the thickness of the electrode sheet 1 is determined to be larger than the preset target value in the thickness comparison step S50. The control step S70 may include: a first control signal output step S71 in which the controller 60 outputs a control signal for increasing the thickness of the electrode sheet 1 when the thickness of the electrode sheet 1 is determined to be smaller than the preset target value in the thickness comparison step S50 and the force applied to each of the pair of sheet forming rollers 20 is smaller than the reference value; a second control signal output step 72 in which the controller 60 outputs a control signal for reducing the thickness of the electrode sheet 1 when the thickness of the electrode sheet 1 is determined to be larger than the preset target value in the thickness comparison step S50 and the force applied to each of the pair of sheet forming rollers 20 is larger than the reference value; and a hunting determination step S73 in which the controller 60 determines that an intermittent hunting phenomenon occurs when the thickness of the electrode sheet 1 is determined to be smaller than the preset target value in the thickness comparison step S50 and the force applied to each of the pair of sheet forming rollers 20 is larger than the reference value or when the thickness of the electrode sheet 1 is determined to be larger than the preset target value in the thickness comparison step S50 and the force applied to each of the pair of sheet forming rollers 20 is smaller than the reference value.

Prior to the thickness comparison step S50, the thickness measurement step S30 in which the thickness sensor 40 measures the thickness of the electrode sheet 1, and the force measurement step S40 in which the first force sensor 30 connected to each of the pair of sheet forming rollers 20 measures the force applied to each of the pair of sheet forming rollers 20 may be performed.

The thickness comparison step S50 is a step in which the controller 60 compares the thickness of the electrode sheet 1 received from the thickness sensor 40 with the preset target value.

In the thickness comparison step S50, the controller 60 may determine whether the thickness of the electrode sheet 1 is smaller than the preset target value. The controller 60 may perform the force comparison step S60 when the thickness of the electrode sheet 1 is smaller than the preset target value, and determine whether the thickness of the electrode sheet 1 is larger than the preset target value when the thickness of the electrode sheet 1 is not smaller than the preset target value.

The controller 60 may perform the force comparison step S60 when the thickness of the electrode sheet 1 is larger than the preset target value, and determine whether the thickness of the electrode sheet 1 is equal to the preset target value when the thickness of the electrode sheet 1 is not larger than the preset target value.

The controller 60 may perform the normal operation determination step S80 when the thickness of the electrode sheet 1 is determined to be equal to the preset target value.

In the thickness comparison step S50, the number of cases in which the thickness of the electrode sheet 1 is compared with the preset target value is three as described above, and the thickness comparison step S50 may be divided into a first thickness comparison step S51, a second thickness comparison step S52, and a third thickness comparison step S53.

The first thickness comparison step S51 is a step in which the controller 60 determines whether the thickness of the electrode sheet 1 is smaller than the preset target value.

The second thickness comparison step S52 is a step in which the controller 60 determines whether the thickness of the electrode sheet 1 is larger than the preset target value.

The third thickness comparison step S53 is a step in which the controller 60 determines whether the thickness of the electrode sheet 1 is equal to the preset target value.

The processing order of the first thickness comparison step S51 to the third thickness comparison step S53 may be changed.

A force comparison step performed according to a comparison result in the first thickness comparison step S51 may be referred to as a first force comparison step S61, and a force comparison step performed according to a comparison result in the second thickness comparison step S52 may be referred to as a second force comparison step S62.

The force comparison step S60 is a step performed when the controller 60 determines that the thickness of the electrode sheet 1 is smaller than the preset target value in the thickness comparison step S50 or determines that the thickness of the electrode sheet 1 is larger than the preset target value in the thickness comparison step S50.

In the force comparison step S60, when the thickness of the electrode sheet 1 is determined to be smaller than the preset target value in the thickness comparison step S50, the controller 60 may determine whether the force applied to each of the pair of sheet forming rollers 20 received from the first force sensor 30 is smaller than the preset reference value. In the force comparison step S60, when the force applied to each of the pair of sheet forming rollers 20 received from the first force sensor 30 is smaller than the preset reference value, the controller 60 may perform the first control signal output step S71. In the force comparison step S60, when the force applied to each of the pair of sheet forming rollers 20 received from the first force sensor 30 is larger than the preset reference value, the controller 60 may perform the hunting determination step S73 and then perform feedback to the thickness measurement step S30. This may be referred to as the “first force comparison step S61”.

In the force comparison step S60, when the thickness of the electrode sheet 1 is determined to be larger than the preset target value in the thickness comparison step S50, the controller 60 may determine whether the force applied to each of the pair of sheet forming rollers 20 received from the first force sensor 30 is larger than the preset reference value. In the force comparison step S60, when the force applied to each of the pair of sheet forming rollers 20 received from the first force sensor 30 is larger than the preset reference value, the controller 60 may perform the second control signal output step S72. In the force comparison step S60, when the force applied to each of the pair of sheet forming rollers 20 received from the first force sensor 30 is smaller than the preset reference value, the controller 60 may perform the hunting determination step S73 and then perform feedback to the thickness measurement step S30. This may be referred to as the “second force comparison step S62”.

In the hunting determination step S73, “hunting” means determining that there is a malfunction that may occur intermittently in the first force sensor 30.

In the first control signal output step S71, the controller 60 may output one of a control signal for increasing the opening ratio of the material feeder 10, a control signal for increasing the discharge pressure of the material feeder 10, and a control signal for increasing the gap between the pair of sheet forming rollers 20 through the gap adjuster 50. In the second control signal output step S72, the controller 60 may output one of a control signal for reducing the opening ratio of the material feeder 10, a control signal for reducing the discharge pressure of the material feeder 10, and a control signal for reducing the gap between the pair of sheet forming rollers 20 through the gap adjuster 50.

The first control signal output step S71 is a step in which the controller 60 outputs a control signal for adjusting the thickness of the electrode sheet 1 manufactured. The controller 60 may output a control signal for increasing the thickness of the electrode sheet 1.

The second control signal output step S72 is a step in which the controller 60 outputs a control signal for adjusting the thickness of the electrode sheet 1 manufactured. The controller 60 may output a control signal for reducing the thickness of the electrode sheet 1.

According to the present disclosure, since the controller 60 outputs the control signals by performing the process including the thickness comparison step S50 and force comparison step S60 described above, it is possible to enable a process operation to be performed more stably in manufacture and thickness adjustment of the electrode sheet 1 and enable the electrode sheet 1 to be manufactured with a uniform thickness, and since the thickness of the electrode sheet 1 is controlled on the basis of a currently measured value, it is possible to enable a highly reliable process and control to be performed.

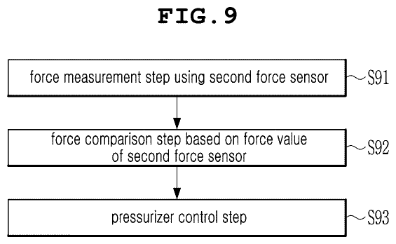

FIG. 9 is a flowchart illustrating a method of using a blade and a second force sensor in the method for manufacturing the dry electrode sheet according to the embodiment. FIG. 5 and FIG. 6 will be referenced together.

The method for manufacturing the dry electrode sheet according to the present disclosure may further include: a step S91 in which a second force sensor 80 measures a force applied to a blade 70 disposed on each of the pair of sheet forming rollers 20 in a direction in which the pair of sheet forming rollers 20 are moved farther away from each other; a step S92 in which the controller 60 compares a force value received from the second force sensor 80 with a preset setting value; and a step S93 in which the controller 60 controls a pressurizer 90 that pressurizes the blade 70 toward the sheet forming roller 20 so that the blade 70 pressurizes the sheet forming roller 20 when the force applied to the blade 70 is larger than the preset setting value.

The steps of the method of using the blade 70 and the second force sensor 80 as described above may utilize the elements of the apparatus including the blade 70, the second force sensor 80, and the pressurizer 90 described with reference to FIGS. 5 and 6.

Referring to FIGS. 5 and 6, the blade 70 may be disposed in contact with each of the pair of sheet forming rollers 20. The second force sensor 80 may be connected to measure a force applied in a direction in which the pair of sheet forming rollers 20 are moved farther away from each other via the blade 70. The pressurizer 90 may be connected to the blade 70 to pressurize the blade 70 toward the sheet forming roller 20.

As described above, the pressurizer 90 may use a pressurizing cylinder 91 or a pressurizing rotary motor 92 depending on whether the gap adjuster 50 is a linear type or a rotary type.

The pair of sheet forming rollers 20 that pressurize the electrode material to form the electrode sheet 1 are rotating bodies that are rotationally driven. Basically, a force exists between the pair of sheet forming rollers 20 to move the pair of sheet forming rollers 20 farther away from each other due to the electrode material. In order to maintain the thickness of the electrode sheet 1 manufactured, a force needs to be applied to the pair of sheet forming rollers 20 in a direction in which the pair of sheet forming rollers 20 are moved closer to each other so that the gap therebetween is maintained.

To this end, the second force sensor 80 may measure the force applied in a direction in which the pair of sheet forming rollers 20 are moved farther away from each other via the blade 70, the controller 60 may compare the force value received from the second force sensor 80 with the preset setting value, and when the force applied to the blade 70 is larger than the preset setting value, the controller 60 may control the operation of the pressurizer 90 to a larger value than the preset setting value to pressurize the blade 70 toward the sheet forming roller 20.

Accordingly, it is possible to prevent the pair of sheet forming rollers 20 from being moved farther away from each other due to the electrode material while the pair of sheet forming rollers 20 are in operation, continuously maintain the gap between the pair of sheet forming rollers 20 in their initial installation state, and prevent occurrence of deviation in the thickness of the electrode sheet 1 manufactured.

The present disclosure has been described in detail with embodiments thereof. However, the above is merely an example in which the principles of the present disclosure, and other configurations may be included or substituted with other elements without departing from the scope of the present disclosure.

What is claimed is:

1. An apparatus for manufacturing a dry electrode sheet, the apparatus comprising:
a material feeder configured to supply an electrode material;
a pair of sheet forming rollers facing each other and configured to form an electrode sheet by pressurizing the electrode material supplied from the material feeder;
a first force sensor connected to each of the pair of sheet forming rollers and configured to measure a force applied to each of the pair of sheet forming rollers;
a thickness sensor configured to measure a thickness of the electrode sheet;
a gap adjuster connected to each of the pair of sheet forming rollers and configured to adjust a gap between the pair of sheet forming rollers; and
a controller configured to control the gap adjuster to adjust the gap between the pair of sheet forming rollers on the basis of a force value measured by the first force sensor so that the thickness of the electrode sheet received from the thickness sensor matches a target value.

2. The apparatus of claim 1, wherein the controller controls an opening ratio of the material feeder or a discharge pressure of the material feeder so that the thickness of the electrode sheet received from the thickness sensor matches the target value.

3. The apparatus of claim 1, wherein the first force sensor comprises a load cell connected to one or each of the pair of sheet forming rollers and configured to measure a force applied in a direction in which the pair of sheet forming rollers are moved farther away from or closer to each other, and
the thickness sensor comprises any one of a spectral interference-type thickness sensor, an infrared absorption-type thickness sensor, and a radiation-type thickness sensor.

4. The apparatus of claim 1, wherein the gap adjuster comprises:
a linear-type gap adjuster configured to move one or each of the pair of sheet forming rollers and linearly move the pair of sheet forming rollers in a direction in which the pair of sheet forming rollers are moved closer to or farther away from each other; or
a rotary-type gap adjuster configured to rotate one of the pair of sheet forming rollers clockwise or counterclockwise around an axis outside the sheet forming roller and rotate the remaining one of the pair of sheet forming rollers counterclockwise or clockwise around an axis outside the sheet forming roller so that the pair of sheet forming rollers are rotated in opposite directions and moved in a direction closer to or farther away from each other.

5. The apparatus of claim 1, further comprising:
a blade disposed on each of the pair of sheet forming rollers and positioned so as to be in contact with each of the pair of sheet forming rollers in a direction in which the pair of sheet forming rollers are moved farther away from each other;
a second force sensor configured to measure a force applied to the blade in a direction in which the pair of sheet forming rollers are moved farther away from each other; and
a pressurizer connected to the blade and configured to pressurize the blade toward the sheet forming roller,
wherein the controller controls the pressurizer on the basis of a force value received from the second force sensor.

6. The apparatus of claim 5, wherein the blade is a plate-shaped body with a length corresponding to that of each of the pair of sheet forming rollers,
the second force sensor is a load cell, and
the pressurizer is a pressurizing cylinder with a cylinder rod connected to the blade or a pressurizing rotary motor with a rotation shaft connected to the blade.

7. A method for manufacturing a dry electrode sheet, the method comprising:
an electrode material supply step in which a material feeder supplies an electrode material to a pair of sheet forming rollers;
an electrode sheet formation step in which the pair of sheet forming rollers are rotated to pressurize the electrode material, thereby forming an electrode sheet;
a thickness measurement step in which a thickness sensor measures a thickness of the electrode sheet;
a force measurement step in which a first force sensor connected to each of the pair of sheet forming rollers measures a force applied to each of the pair of sheet forming rollers;
a thickness comparison step in which a controller compares the thickness of the electrode sheet received from the thickness sensor with a preset target value;
a force comparison step in which the controller compares the force received from the first force sensor with a preset reference value; and
a control step in which the controller controls a gap adjuster that adjusts a gap between the pair of sheet forming rollers on the basis of a force value measured by the first force sensor so that the thickness of the electrode sheet received from the thickness sensor matches the target value.

8. The method of claim 7, further comprising:
a normal operation determination step in which the controller determines that the thickness of the electrode sheet is in a normal state when the thickness of the electrode sheet is determined to match the preset target value in the thickness comparison step.

9. The method of claim 7, wherein the force comparison step is performed when the controller determines that the thickness of the electrode sheet is smaller than the preset target value in the thickness comparison step or determines that the thickness of the electrode sheet is larger than the preset target value in the thickness comparison step, and
the control step comprises:
a first control signal output step in which the controller outputs a control signal for increasing the thickness of the electrode sheet when the thickness of the electrode sheet is determined to be smaller than the preset target value in the thickness comparison step and the force applied to each of the pair of sheet forming rollers is smaller than the reference value;
a second control signal output step in which the controller outputs a control signal for reducing the thickness of the electrode sheet when the thickness of the electrode sheet is determined to be larger than the preset target value in the thickness comparison step and the force applied to each of the pair of sheet forming rollers is larger than the reference value; and
a hunting determination step in which the controller determines that an intermittent hunting phenomenon occurs when the thickness of the electrode sheet is determined to be smaller than the preset target value in the thickness comparison step and the force applied to each of the pair of sheet forming rollers is larger than the reference value or when the thickness of the electrode sheet is determined to be larger than the preset target value in the thickness comparison step and the force applied to each of the pair of sheet forming rollers is smaller than the reference value.

10. The method of claim 9, wherein in the first control signal output step, the controller outputs one of a control signal for increasing an opening ratio of the material feeder, a control signal for increasing a discharge pressure of the material feeder, and a control signal for increasing a gap between the pair of sheet forming rollers through the gap adjuster, and
in the second control signal output step, the controller outputs one of a control signal for reducing the opening ratio of the material feeder, a control signal for reducing the discharge pressure of the material feeder, and a control signal for reducing the gap between the pair of sheet forming rollers through the gap adjuster.

11. The method of claim 7, further comprising:
a step in which a second force sensor measures a force applied to a blade disposed on each of the pair of sheet forming rollers in a direction in which the pair of sheet forming rollers are moved farther away from each other;
a step in which the controller compares a force value received from the second force sensor with a preset setting value; and
a step in which the controller controls a pressurizer that pressurizes the blade toward the sheet forming roller so that the blade pressurizes the sheet forming roller when the force applied to the blade is larger than the preset setting value.
